(19) United States
(12) Patent Application Publication
(10) Pub. No.: US 2020/0049871 A1
(43) Pub. Date: Feb. 13, 2020

(54) OPTICAL DEVICE WITH REFLECTIVE MULTICOLORED AND EMISSIVE IMAGES

(71) Applicants: YINGQIU JIANG, SUNNYVALE, CA (US); AHARON HOCHBAUM, BERKELEY, CA (US)

(72) Inventors: YINGQIU JIANG, SUNNYVALE, CA (US); AHARON HOCHBAUM, BERKELEY, CA (US)

(21) Appl. No.: 16/342,957

(22) PCT Filed: Oct. 23, 2017
(86) PCT No.: PCT/US2017/057772

§ 371 Date: Apr. 17, 2019

(51) Int. Cl. G02B 5/30; G02B 5/26; B42D 25/29; B42D 25/387; C09K 19/38; C09K 11/06

(52) U.S. Cl. CPC G02B 5/3016; G02B 5/3075; G02B 5/26; C09K 11/06; B42D 25/387; C09K 19/38; B42D 25/29

(57) ABSTRACT

The current invention relates to a patterned optical device comprises a patterned cholesteric liquid crystal polymer layer where different domains of the pattern reflect different colors and where luminescent molecules are embedded in a subset of said reflective domains or in a separate layer. The current invention also relates to an optical security device comprises overt reflective OVD images and covert luminescent images with multiple authentication levels including detection of polarized reflections and emissions.

### BACKGROUND OF THE INVENTION

Counterfeiting of consumer goods, currencies, financial documents and identification cards is countered by a large variety of optical security measures designed to deter and defeat this illicit activity. Optical variable devices (OVDs) that change their apparent color (color-shift or blue-shift) when viewed at different angles are particularly effective optical security devices for anti-counterfeiting measures and brand protection applications. Among OVDs, cholesteric liquid crystal polymer (CLCP) films or pigments have become prevalent in the security printing industry. CLCP laminates or pigments offer two visual security levels based on a unique color shift effect and on a selective polarized reflection effect. Both effects can be utilized as distinctive signatures for optical authentication. The two optical effects cannot be reproduced by counterfeiters employing standard reproduction techniques or using non-CLCP materials. A third, forensic, security level is based on the CLCP unique and tunable reflection spectrum.

Users of optical security devices prefer labels with additional functionalities. In particular, labels embedding information or identifying patterns (e.g. barcodes or logos) that are visually recognizable or machine readable are preferred over blank colored CLCP labels that are currently in use. Therefore, patterned CLCP labels or laminates that can be fabricated by conventional printing techniques to provide informative, multicolor information, in addition to OVD and polarized reflection effects, are very useful.

CLCP are essentially transparent films and, therefore, can be applied on standard printed labels, adding information without obscuring the underlying print. This is a particularly useful feature for information dense labels such as on pharmaceutical packaging and for nondistractive labels on artwork.

Another prized optical security feature is a covert (hidden, invisible, latent) image or information, which are highly resistant to reprographic counterfeiting. One simple yet useful technique is the printing of invisible luminescent images that are revealed by excitation light illumination, usually by UV. Since the emission wavelength can be placed sufficiently far from the excitation light, viewing conditions can be arranged or simple filters be used to observe a high contrast emission image. Luminescent materials, and particularly fluorescent dyes with high quantum yield, can be embedded in low concentration in many carrier materials such that their presence is not noticed under ambient conditions. A large variety of fluorescent dyes exists and many different custom combinations of dyes can be used to print customized covert images.

As counterfeiters continuously expand their techniques and improve their sophistication, more complex devices are required to deter and defeat them. A common anti-counterfeiting strategy is to employ multiple distinct optical devices with multiple effects to make the security label or laminate harder to counterfeit. It is also important for a single security device to provide different security levels that can be used for authentication under different circumstances and by different users who have diverse authentication needs or capabilities. These levels may range from devices that provide visual authentication by the naked-eye; inspection using simple devices like filters or polarizers; small mobile verifiers and up to the forensic level, where an optical security device is authenticated using expensive dedicated or general scientific instrumentation such as a spectrometer. Therefore, technologies that can provide both overt visual optical effects and covert images are highly secure and very useful as anti-counterfeiting measures.

U.S. Pat. No. 9,243,169 discloses a laminate structure comprises: a transfer tape, background layer, overt layer, microprint layer, covert fluorescence layer and a clear top film, where the device is viewed from the clear film side. One or more of the internal layers are OVD devices, based on CLCP or interference pigments, with a repeating pattern. The fluorescent layer also comprises of a repeating pattern and is the first information containing layer to face the viewer. Since the OVD device has one or more coatings of flake particles, it is not highly transparent and has light scattering properties. These features dictate the placement of the covert transparent fluorescent pattern in between the observer and the OVD layer so that the covert pattern can be seen clearly when excited. As a result, the fluorescence from a security device of this configuration is isotropic and devoid of any special features such as polarized emission and other large effects that a CLCP host may have on the emission spectrum.

U.S. Pat. No. 7,794,620 discloses single CLCP layer containing various organic or non-organic nanoparticles and in particular fluorescent pigments with a preferred size of 10-500 nm. The problem addresses by this patent is a deterioration of the optical properties of the CLCP layer, a reduction of its reflection in particular, as a result of misalignment of the CLC molecules by the guest pigments and by various surfactants used to disperse said pigments. The solution comprises special CLCP compounds where nanoparticles can be dispersed without surfactants and without diminishing their reflection. Such a system of guest particles, which is incorporated into special CLCP compounds, is clearly distinct from dye molecules guests that, unlike pigments, can be aligned by the host and do not cause light scattering. Since this patent is not concerned specifically with optical security devices, there is no mention of any special fluorescent features in these material systems such as polarized emission.

U.S. Pat. No. 6,733,689 discloses LCP material composition which can be chiral and be used for counterfeiting-proof marking. Fluorescent dyes or pigments are incorporated into an optional separate layer, which is in contact with the CLCP. The structure of such an optical security device is not disclosed and, therefore, its fluorescence may not be polarized.

U.S. Pat. No. 8,490,879 discloses a three-layer thin-film security device which has broadband absorption over the visible range for all incidence angles and, as a result, it appears black from one side. A fourth additional element: a color-shifting CLCP layer or a luminescent layer can be added on the black face of the device. This structure does not provide simultaneous polarized reflection and emission.

U.S. Pat. No. 6,899,824 discloses a process and a structure comprises a substrate, a liquid crystalline layer which can be a CLCP and a non-liquid crystalline layer which may contain a fluorescent dye or pigment. In this structure the observed fluorescent is essentially not polarized and the CLCP layer is not patterned.

U.S. Pat. No. 6,291,065 discloses materials and flakes made of them, where the fluorescent dye is a chromophore group, which can be visible, that is chemically bonded to the CLCP molecules rather than be a dopant embedded in the CLCP as in the current invention. An optical element comprises of said flakes does not constitute a single uniform layer and does not exhibit multiple reflective colors.

It is an aim of the current invention to provide a unique solution not addressed by the prior art, which includes multiple optical effects, both overt and covert, and which provides all security levels in a single device that is cheap to manufacture but very sophisticated to defeat counterfeiters. Such unique combination of properties can be achieved by incorporating or combining a fluorescent covert image with a multicolored overt images in a CLCP OVD device. When fluorescent dyes are combined with a CLCP layer, having overlapping emission and reflection bands in the visible range, new synergetic optical effects are observed, which are not present when fluorescent dyes are deployed in isolation, thus enhancing the overall security of such authentication devices.

### SUMMARY OF THE INVENTION

The current invention discloses optical device structures that comprise an overt pattern of multiple colors in a single CLCP layer and a covert luminescent pattern. Under ambient illumination, the overt pattern exhibits a simultaneous color-shift effect of all colored domains. Since the reflection from CLCP is circularly polarized, viewing the device through an opposite circular polarizer will extinguish the patterned reflection while the sense circular polarizer will transmit it. These features are common to all embodiments.

Illuminating the optical device with excitation radiation reveals a covert emission background or an emissive image. Depending on whether the luminescent material is embedded in the CLCP or in a separate layer or print, and whether its emission peak is inside or outside the reflection bands of some of the domains constituting the overt image, the covert image will exhibit a diversity of effects when viewed through circular polarizers or at multiple angles or both.

The above diverse and unique combination of optical effects increases the security level against counterfeiters and provides all authentication levels from visual inspection to forensic authentication.

In a first embodiment, the optical device structure comprises a substrate coated with a first transparent carrier layer embedded with a uniformly distributed invisible luminescent materials; a second layer of a patterned CLCP, where different domains in the pattern may reflect different colors; and an optional transparent third top-coating.

In a second embodiment, the device structure is the same as in the first embodiment except that the first carrier layer embedded with luminescent materials is patterned to form a covert image or comprises a print of a carrier embedded with luminescent materials.

In a third embodiment, the optical device structure comprises a substrate coated with a multicolor patterned CLCP layer where a subset of the colored domains is embedded with a uniformly distributed invisible luminescent material and where the peak of the luminescent material is outside the reflection bands of said colored domains.

In a fourth embodiment, the optical device structure comprises a substrate coated with a multicolor patterned CLCP layer, where a subset of the colored domains is embedded with a uniformly distributed invisible luminescent material and where the peak of the luminescent material is inside the reflection bands of said colored domains.

In a fifth embodiment, the optical device structure comprises a substrate coated with a multicolor patterned CLCP layer, where a first subset of the colored domains is embedded with a uniformly distributed invisible first luminescent material and where the emission peak of the luminescent material is outside the reflection bands of said first colored domains; and where a second subset of the colored domains is embedded with a uniformly distributed invisible second luminescent material and where the emission peak of the luminescent material is inside the reflection bands of said second colored domains.

### BRIEF DESCRIPTION OF THE DRAWINGS

FIG. 1A illustrates schematically a structure of a patterned multicolor reflective device comprises a substrate; a first transparent carrier layer embedded with a uniformly distributed invisible luminescent material and a second layer of a patterned CLCP, where different domains in the pattern reflect different colors. FIG. 1A is a cross-sectional view of said device showing colored reflections from different CLCP domains under ambient illumination. FIG. 1B demonstrate LH polarized reflection from a CLCP domain that is blocked by a RH-polarizer. FIG. 1C illustrated UV excitation of the luminescent material and its emission light. FIG. 1D demonstrates that the RH polarization of the emission light, which is transmitted by the LH-CLCP, is transmitted by a RH-polarizer. FIG. 1E shows a device structure similar to FIG. 1A except that the luminescent material layer is patterned. FIG. 1F illustrates a device structure where the unpatterned luminescent layer is on the opposite side of the substrate from the patterned CLCP layer. FIG. 1G illustrates a device structure where a patterned luminescent layer is on the opposite side of the substrate from the patterned CLCP layer.

FIG. 2A illustrates schematically a structure of a patterned multicolor reflective device comprises a substrate and a layer of a patterned CLCP, where different domains in the pattern reflect different colors and part of the domains are embedded with invisible luminescent materials. The emission peaks of the luminescent materials are outside the reflection bands of the CLCP. FIG. 2A illustrates a cross-sectional view of said device under ambient illumination showing colored reflections from said domains. FIG. 2B shows said device under UV illumination and emission from a subset of domains that are embedded with a fluorescent material.

FIG. 3A illustrates schematically a structure of a patterned multicolor reflective device comprises a substrate and a layer of a patterned CLCP, where different domains in the pattern reflect different colors and part of the domains are embedded with invisible luminescent materials. The emission peaks of the luminescent materials are inside the reflection bands of the CLCP. FIG. 3A illustrates a cross-sectional view of said device under ambient illumination showing colored reflections from said domains. FIG. 3B shows said device under UV illumination and emission from a subset of domains that are embedded with a fluorescent material.

FIG. 4A illustrates schematically the structure of a patterned multicolor reflective device comprises a substrate and a layer of a patterned CLCP, where different domains in the pattern reflect different colors. A first luminescent material is embedded in a first subset of the domains and a second luminescent material is embedded in a second subset of the domains. FIG. 4A illustrates colored reflection from said patterned CLCP under ambient illumination. FIG. 4B shows said device under UV illumination and emission from a first subset of domains that are embedded with a first fluorescent material and emission from a second subset of domains that are embedded with a second fluorescent material.

### DETAILED DESCRIPTION OF PREFERRED EMBODIMENTS

Cholesteric liquid crystals (CLC) constitute a LC phase where elongated shape molecules are, on the average, parallel one to the other except for a small, consistent twist around a direction that is perpendicular to the molecular long axis. The twisting of the molecular orientation results from the molecular chiral structure, one where a molecule's structure cannot be superimposed on its mirror image. The axis of twist is the optical axis of the system. The fixed rate rotation builds up to a 1D periodic structure along the optical axis. The distance required for a 360-degree rotation, the pitch (P), is the structure's period.

In practice, CLC liquids are a mixture of a nematic LC (NLC) component, which lacks any twist, with a chiral dopant and, therefore, it is known also as a “chiral nematic”. One important advantage of a chiral nematic mixture is that the pitch can be modified continuously by adjusting the concentration of the chiral component.

Since the constituting molecules are anisotropic, the index of refraction of the NLC and CLC phases is anisotropic as light propagates faster along the molecular axis than perpendicular to it. Such a uniaxial medium has two different refraction indices: nₑ and n₀. The optical properties of CLC are expressed in terms of an average index n=(nₑ+n₀)/2 and the birefringence Δn=nₑ−n₀.

The periodic twisted structure of a uniform pitch is the lowest energy configuration of a liquid CLC layer. However, unless planar surface conditions are provided, a short pitch CLC layer is likely to adopt a metastable, multi-domain structure, where the domains have the same pitch, but each orients its optical axis in a random direction. The multi-domain state, known as a “focal conics” texture, is associated with a strong light scattering. However, if a CLC layer has one or two confining substrates that are treated to force the adjacent molecules to align along a single direction in the substrates' plane, the CLC will adopt a uniform planar configuration where its optical axis is perpendicular everywhere to the substrates. Only the planar configuration is of interest herein. In few cases it is possible to achieve a planar configuration on a single aligning substrate, where one CLC surface interfaces air. A liquid CLC monomer can be aligned in its liquid phase in a planar configuration and then be UV polymerized into a solid polymer (CLCP), essentially freezing its previous configuration. As a result, CLC and their polymeric analogue, CLCP, have identical structures and, hence, also exhibit identical optical properties.

The main manifestation of the periodic chiral structure in a planar configuration, is the appearance of a reflection band of circularly polarized light, of the same handedness as the chirality of the cholesteric structure. The center wavelength of the reflection band, λ₀, is related to the pitch by: λ₀=nP, where n is the average index-of-refraction of the CLCP. The width of the reflection band, Δλ, is related to the birefringence: Δλ=ΔnP. Typical reflection bands in the visible range are 30-60 nm wide. A right handed (RH) CLCP, for example, reflects completely the RH circular polarization component of unpolarized radiation within the reflection band. It fully transmits the LH polarization component within the reflection band. A CLCP is essentially transparent to both polarizations at all wavelengths outside the reflection band. CLCP layers, particularly on a black background, exhibit bright reflection colors. Their circularly polarized reflection can be extinguished when viewed through a circular polarizer of the opposite handedness.

The intrinsic reflection color of a planar CLCP layer, customarily characterized by λ₀, is the color seen for light incidence normal to the CLCP plane (along the optical axis). For light incidence at an angle θ to the optical axis, the reflected color λ is shorter than the intrinsic color λ₀, and is given approximately by: λ=λ₀ cos(θ). This effect, where the perceived color is of shorter wavelength with increasing viewing angle, is known as the “blue shift”, or “color shift”, or “color travel”, or OVD effect of the CLCP color. The blue-shift effect is very important in optical security applications since it cannot be replicated by any known reprographic counterfeiting method. At the same time, the effect is readily observable and verifiable by the naked eye. Other 1D periodic structures (e.g., periodic thin film structures) also possess this useful feature and are known collectively as Optical Variable Devices (OVD).

The CLCP circularly polarized reflection is unique among OVD devices. It is useful for optical security applications as it can be easily detected with a circular polarizer, having an opposite circular sense to the CLCP, by extinguishing the polarized reflection and, therefore, authenticating the CLCP device. A CLCP layer has also a forensic security level where the details of its reflection band, which can be customized, are verified using a spectrometer.

Since the reflection from a CLCP planar layer is specular (it follows Snell's reflection law), the blue-shift effect is observed only in specular configurations where the light source, the detector and the optical axis at the incidence point, are in the same plane and the incidence angle is equal the reflection angle. In practice, many environments frequently have a dominant light source, usually the closest illumination source to the CLCP. An observer can always create a specular configuration, by adjusting the tilt of the CLCP plane with respect to the eye and the dominant light source, to observe the strong (˜50%) polarized color reflection. By varying the observation angle, the observer can follow the color shift effect.

For non-specular observational configurations, the CLCP is essentially transparent. This feature is also useful as it allows overlaying a CLCP layer on top of standard printed information without obscuring it for most observational configurations. The CLCP's reflective image is dominant and visible only at or near the specular angles.

In NLC and CLC phases, the molecules are oriented, on the average only, along a single direction: the “director” vector n. In NLC the director field is uniform: n₀. In a chiral CLC the director n rotates in a helical fashion around an axis perpendicular to n. On a molecular scale the twisting effect is negligible and the local environment of a CLC molecule is essentially the same as in a NLC phase.

An important concept for describing properties of anisotropic liquids, such as NLC or CLC, is the order parameter “S”. S describes how well the thermally fluctuating molecules align along the local n. In regular (isotropic) liquids even anisotropic molecules have no preferred direction. The order parameter for isotropic liquids is S=0. In the LC phases the anisotropic molecules tend to be mutually parallel and possess a typical order parameter in the range S=0.5-0.75. S=1 corresponds to an ideal LC phase where all the molecules are oriented along n with no fluctuations. LC phases with a positive S but less than about 0.4 do not exist.

CLC in general are not absorptive materials unless they host guest dyes or pigments which absorb visible light. When a dopant molecule is dissolved in a LC host, its orientational properties depend to a large degree on its shape anisotropy and its interaction with the LC molecules. In many cases the orientational distribution of a dopant molecules is isotropic even though their host LC material has S>0. However, dopant molecules with significant shape anisotropy and/or favorable interaction with the LC host can become oriented and possess an order parameter S>0. Dye molecules that are aligned by their LC host, are known as “dichroic dyes”. Once aligned, they exhibit an anisotropic absorption property. Dichroic dyes have significantly higher absorption of light polarized linearly along n than of light polarized perpendicular to n. As a result, a planar NLC layer doped with a dichroic dye acts like a linear polarizer: transmitting linear polarization perpendicular to n while significantly attenuating the polarization parallel to n. If the dichroic dye is fluorescent, its emission will, in general, also be polarized: the fluorescence emission that is parallel to n is stronger than emission perpendicular to n. If the order parameter of a fluorescent dye in a nematic host is S=0, the fluorescent emission is unpolarized.

The optical properties of a CLC material within its reflection band are those of a one dimensional photonic gap material. The existence of a high reflection band demonstrates that circularly polarized light, of the same handedness as the chirality of the CLC, is forbidden from propagating through a thick CLC layer. When a luminescent guest in a planar CLC host layer, said guest has its emission peak substantially inside the CLC's reflection band, is excited by UV light, its emission perpendicular to the layer is essentially circularly polarized in the opposite handedness to the CLC chirality. This is true even for fluorescent dyes having S=0. The polarized emission from a CLC is characterized by the intensity ratio of the transmitted left-handed (LH) to the right-handed (RH) polarizations: r=I_{LH}/I_{RH} and by the dissymmetry factor g=(2 I_{LH}−2I_{RH})/ (I_{LH}+I_{RH}). For a LH CLC, typical values within the reflection band are: r=0.15 and g˜−1.5. Circularly polarized emission is unique to the CLC medium and its color is an indication of where is the CLC's reflection band.

The emission spectrum of fluorescent dyes in isotropic hosts is not polarized and has essentially the same shape (except for possible shifts of the peak emission) in most host media. In contrast, the shape of the emission spectrum changes drastically for the forbidden polarization in CLC hosts. A unique property of dye fluorescence in a CLC medium is a sharp increase in the density of states of the non-propagating polarization, typically at the long-wavelength edge of the reflection band. The fluorescence of the nominally forbidden polarization, which is very weak throughout the reflection band, exhibits a prominent intensity spike near the long edge of the band. The emission spectrum of the propagating polarization is not affected by the reflection band: it has the same shape as if the fluorescent dye was embedded in the isotropic phase of the CLC material. These unique features of the fluorescence emission from a CLC host are displayed by fluorescent molecules having S>0 as well as by molecules having S=0.

The polarization of the emission within the reflection band and the presence of a spike of the polarized fluorescence near the reflection-band's edge can be detected by comparing the emission when viewing the CLC through a LH or a RH polarizer. The two views will differ in the intensity of the emission as well as in its color.

In some implementations the fluorescent dye is embedded in a separate isotropic host resulting an isotropic emission. It is assumed, however, that the emission peak is within one the reflection bands of an adjacent CLCP layer. When this emission is viewed through the CLC, it becomes polarized in the opposite sense to the CLC chirality.

In the following discussion, in instances where particular chirality or circularities are assigned, it will be understood that all conclusions remain essentially the same in different instances where the chirality or circularities are simultaneously reversed. Namely, LH chirality or circularities are replaced by RH chirality or circularities and RH by LH.

The current invention discloses optical device structures that comprise an overt pattern of multiple reflective colors from a single CLCP layer and a covert luminescent pattern. The single CLCP layer is in a continuous, solid film format. In embodiments where the luminescent materials are embedded in the CLCP layer, the covert luminescent pattern registers with at least part of the overt pattern or may comprise the background. In embodiments where the luminescent materials are embedded in a separate layer, the overt and covert patterns may fully register, partially register, complement or be entirely separate. A typical device will include a substrate which may be transparent or opaque, having low or high reflection, having a glossy or diffusive surface, reflecting colors or being substantially white or black. In addition, the device may include an optional transparent top-coating layer, on the opposite side from the substrate, which serves as a protection layer for said device.

Luminescent materials are defined herein as fluorescent or phosphorescent molecules. Such molecules can be excited by UV or visible radiation to emit radiation at wavelengths longer than the excitation. In most circumstances the emission is unpolarized unless special measures are taken, such as stretching a polymer film in which the dyes are embedded, or employing special host materials such as CLCPs. The term “luminescent dye” or “fluorescent dye” is used herein to mean: molecules that absorb only UV radiation and are invisible under ambient illumination. The excitation illumination can be applied from either side of the device that does not have an opaque layer. Where one luminescent material is mentioned in the embodiments, it is understood that multiple luminescent materials may be deployed as well.

The CLCP pattern comprise of background domains with a first reflection band corresponding to a first color and image domains comprise a distinct second reflection band corresponding to a second color. The distinction between “background” domains and “image” domains is arbitrary in general. In informative patterns the “image” comprises of domains that convey information while the rest of the domains constitute the “background”. Both background and image comprise, in general, domains with multiple reflective and emissive colors.

The images in CLCP labels are fixed images or serialized images, where the image or information therein varies from one label to the next. The ability to serialize the information on label is an important functionality.

It is understood herein that the following embodiments can be extended to include images comprise of multiple domain of distinct reflection bands and the corresponding multiple distinct colors. The patterns in the CLCP or of the luminescent material comprise general images that can be classified, without limitations, as a mark, text, a logo, a photo, a barcode or a 2D code such as QR code.

In the following embodiments, all references to reflected colors assume a specular reflection configuration where the angle between the dominant ambient light source and the normal to the optical device is substantially equal to the angle between the observer and said normal. The specular angle coincides with the normal if the light source is essentially above the device. If an incidence angle is not specified or implied, the reflective or emissive colors assume normal incidence or propagation. At non-specular viewing configurations, the CLCP is essentially transparent, except for a weak tint, in which case the observed colors are essentially those of the substrate. The emission light is assumed to be observed at normal to the device unless stated otherwise.

One aspect of the present invention is the deliberate choice of the luminescent materials, or the reflection colors, such that in some domains the emission peaks are substantially within the reflection bands. The more the emission spectrum overlaps the reflection band in one domain, the stronger will be the observed polarization dependence effects of the covert image in this domain. The width of a reflection band is given approximately by: Δλ=ΔnP=λ₀Δn/n, and depends strongly on the CLCP's birefringence. Birefringence is a material parameter that is difficult to modify. However, it is well known to those skilled in the art, that broadening of the reflection band can be achieved by a process step that generates a pitch-gradient structure. The pitch in a pitch-gradient CLCP, rather than be a constant throughout the layer, is increasing in value from one surface of the layer to the other such that the reflection bandwidth is given approximately by: Δλ=nΔP. The reflection bandwidth of a pitch-gradient CLCP can be substantially wider than the bandwidth of a constant pitch CLCP and thus can provide more overlap with broad emission spectra of embedded luminescent dyes.

Another aspect of the current invention is to provide a single device with multiple optical effects: overt images exhibiting a color shift effect and polarized reflections as well as covert images based on luminescent materials that also exhibit partially polarized emissions. The polarization aspects of the reflection or emission can be observed by using circular polarizers.

Yet another important aspect of the present invention is to provide a single optical security device that can provide multiple authentication levels from simple visual inspection to forensic authentication. The forensic authentication is achieved by measuring the spectra details of the various CLCP's reflection bands or the emission spectra corresponding to different luminescent materials or by measuring their luminescent lifetime. This aspect permits the production of highly counterfeit-resistant labels, laminates and general optical security devices.

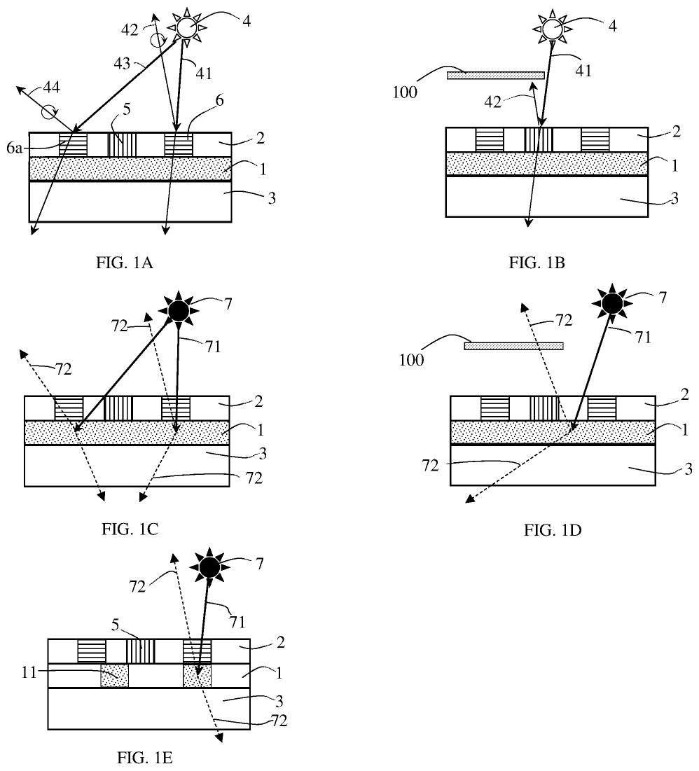

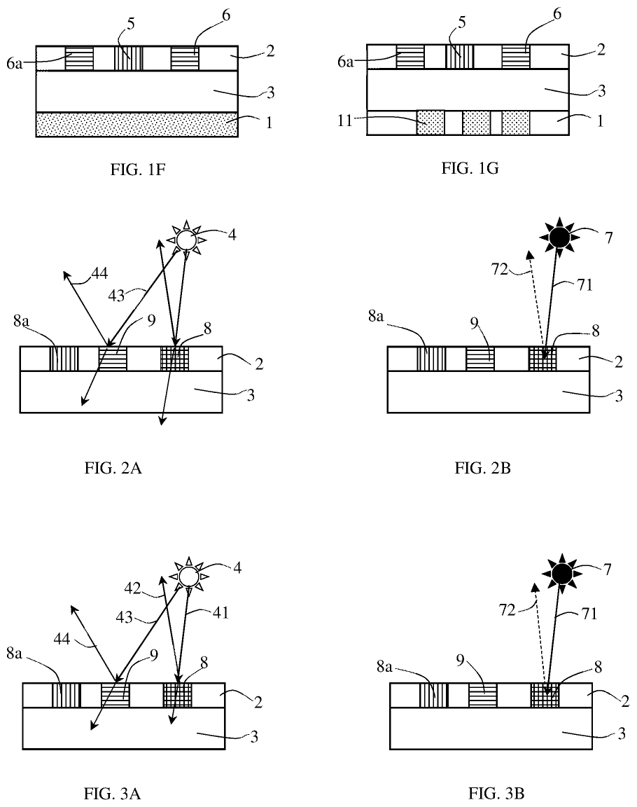

In a first embodiment, the optical device structure, illustrated in FIG. 1A, comprises a substrate 3 coated with a first transparent layer 1 in which a uniformly distributed invisible luminescent material is embedded in a carrier material; a second layer 2 of a patterned CLCP, where different domains of the pattern may reflect different colors (multicolor); and an optional third transparent top-coating layer (not shown). Another implementation of the current embodiment, is a device with a similar structure, as illustrated by FIG. 1F, where said layer 1 and layer 2 are on opposite sides of a transparent substrate 3.

In a non-limiting example of FIG. 1A, domain 5 reflects Green light and domains 6 and 6a reflect Red light 42, all are circularly polarized, when unpolarized light 41 from a white source 4 incidents at essentially normal angle to the device. Layer 1 is embedded with a Blue emitting luminescent material. When the device is viewed under ambient light at large incidence angles all colored domains shift their reflection to shorter wavelength colors. For example, at large angle light incidence 43, the effective reflection band of 6a blue-shifts from Red reflection 42 at near normal incidence to Green reflection 44.

If the CLCP in FIG. 1A reflects LH polarization, viewing it under white ambient light and through a RH polarizer 100, as shown in FIG. 1B, will extinguish all reflections and the device will appear black or dark.

Illuminating the device with an excitation beam 71, as shown in FIG. 1C, preferably from a UV light source 7, and viewing it from the CLCP side, reveals the colored emission 72 from luminescent layer 1. Since the luminescent emission is unpolarized, its RH component will pass through a RH polarizer 100 as depicted in FIG. 1D.

When sources 4 and 7 illuminate the device simultaneously and the device is viewed at a specular angle, the luminescent background modifies the perceived domains colors compared to just ambient illumination. In this configuration both the overt reflection image from layer 2 and the covert emission from layer 1 are visible. However, when the CLCP is LH, introducing a RH polarizer 100 into the viewing path will, as discussed above, block the reflective image while transmitting only said emission.

In a second embodiment, the device structure is the same as in the first embodiment except that layer 1 comprises a print of luminescent material or patterned luminescent domains 11, as shown in FIG. 1E. FIG. 1G illustrates yet another implementation of the current embodiment, where patterned layer 1 is on the opposite side of a transparent substrate 3 from the patterned CLCP layer 2. In both implementations, the covert image of layer 1 is revealed under UV illumination 71 from UV source 7, as shown in FIGS. 1E and 1G. When the device is illuminated simultaneously with both sources 4 and 7 and viewed at a specular angle, the luminescent image modifies the colors or add features to the overt image. Viewing the device at specular configuration but through a RH polarizer 100, extinguishes the overt image, similar to that shown in FIG. 1B, but transmits the covert luminescent image similar to that depicted in FIG. 1D.

In a non-limiting example of the second embodiment, FIG. 1E, the image comprises a Red-reflecting LH-CLCP background domains 6, 6a and a Green-reflecting logo domain 5. A covert Blue-emitting text domain 11 comprises of a fluorescent dye is printed in the first layer 1. Since the LH-CLCP always transmits the RH polarization component of the Blue emission, the text image will always be seen through a RH-polarizer while the reflective LH polarized overt background and logo image will be blocked by said polarizer.

In a third embodiment, the optical device structure, FIG. 2A, comprises a substrate 3, a layer of multicolor patterned CLCP 2 and an optional layer of a transparent top coating (not shown). A subset 8 of the colored reflecting domains, 8a 8 and 9, of said patterned CLCP 2 is embedded with a uniformly distributed invisible fluorescent material where the fluorescent emission peak is outside the reflection bands of said colored domains. As a result, all emission polarizations can propagate through the CLCP and be seen by a viewer along the device' normal. The covert image domains of the current embodiment comprise a subset of the overt image. The visual properties under ambient illumination, as illustrated by FIG. 2A, are similar to those of the second embodiment. Illuminating the device simultaneously with ambient, 4 in FIG. 2A, and UV, 7 in FIG. 2B, sources and viewing it at a specular configuration through a RH polarizer, extinguishes the overt multicolor image but transmits the covert fluorescent image while a LH polarizer will transmit both overt and covert images.

In a non-limiting example of the third embodiment, FIG. 2A, a patterned LH-CLCP 2 comprises of Green-reflecting background domain 9 and Red-reflecting domains 8, a part of a text image, and 8a, a part of a logo image. FIG. 2A depict few of the overt LH reflections for normal 42 and for large angle incidence 44. A Green-emitting fluorescent dye is embedded only in the text domains 8. Under UV illumination 71, FIG. 2B, when the device is viewed along its normal, the CLCP transmits both the RH and LH polarization components 72 of the Green-emitting text such that the covert text is equally visible through a LH or a RH polarizer (not shown). However, when viewed at large angle to the device' normal, the reflection bands of the logo and text blue-shift such that the dye's Green emission peak is now within the text's 8 effective reflection band and only the RH Green polarization is substantially transmitted by the LH CLCP. When viewed through a RH polarizer, varying the viewing angle in this fashion does not affect significantly the appearance of the covert text. However, when viewed through a LH polarizer, the text 8 becomes darker at large viewing angles and its color shifts from Green to Green-Yellow as the LH polarization emission is suppressed throughout the reflection band except for a spike at the long wavelengths side of the effective reflection band.

In a fourth embodiment, the optical device structure, FIG. 3A, comprises a substrate 3, a layer of patterned multicolor CLCP 2 and an optional layer of a transparent top coating (not shown). A subset 8 of the colored domains, 8 8a and 9, in said patterned CLCP is embedded with a uniformly distributed invisible fluorescent material where the fluorescent emission peak is inside the reflection band of part of said colored domains. In the current embodiment the covert image domains comprise a subset of the overt image. Assuming a LH-CLCP, the RH emission 72, FIG. 3B, will propagate unobstructed through the CLCP. The LH emission at wavelengths within the reflection bands will be highly suppressed except for a strong emission spike, usually at the long wavelength side of the reflection band. The visual properties under ambient illumination, FIG. 3A, are the same as in the third embodiment, FIG. 2A. When ambient illumination, in a specular configuration, and excitation radiation are present simultaneously and the device is viewed through a RH polarizer, the overt image is extinguished but the covert fluorescent image remains visible. Viewing the device under UV illumination 71, FIG. 3B, along its normal, interchangeably through a RH and LH polarizer (not shown), will cause the covert image to change its brightness and to exhibit a color shift. In addition, changing from normal viewing to a large angle viewing through a LH polarizer, will also modify the brightness and color of the covert image.

In a non-limiting example of the fourth embodiment, FIG. 3A, a patterned LH-CLCP 2 comprises of Green-reflecting background domain 9 and a Red-reflecting image domains of a logo 8a and text 8. A Red-emitting fluorescent dye is embedded only in the text domain 8. Under UV illumination, 71 in FIG. 3B, the CLCP transmits along its normal the RH polarization 72 of the Red emission but suppresses the LH component except for an emission spike at the long wavelengths side of the Red-reflecting band.

When the device is viewed along its normal through a RH polarizer, the text appears bright Red. When viewed through a LH polarizer the text becomes darker and its color shifts towards the NIR. When viewed at large angle to the device' normal, 43 in FIG. 3A, the reflection band of the logo and text blue-shift to the Green such that the text's 8 Red emission peak is now outside the reflection band. Both LH and RH polarizations of the Red emission 72 can propagate through the CLCP at large angles. Varying the viewing angle in this fashion, while viewed through a RH polarizer, does not affect significantly the appearance of the covert text. However, when viewed through a LH polarizer, the text becomes brighter at large viewing angles and its color shifts from dark-Red to Red.

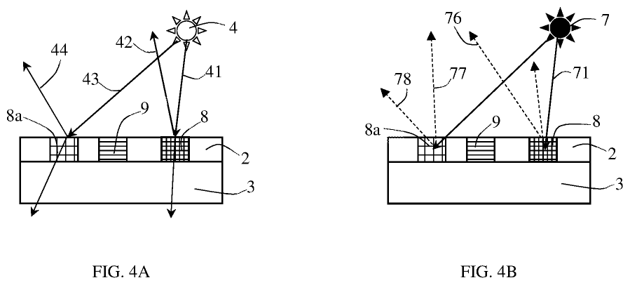

In a fifth embodiment, the optical device structure, FIG. 4A, comprises a substrate 3, a layer of multicolor patterned CLCP 2 and an optional layer of a transparent top coating (not shown). A subset 8 of the colored domains, 8a 8 and 9, in said patterned CLCP is embedded with a uniformly distributed invisible first fluorescent material with a peak emission outside the reflection band of 8; and where a second subset of colored domains 8a is embedded with a uniformly distributed invisible second fluorescent material with an emission peak inside the reflection band of 8a. In the current embodiment the covert image domains comprise a subset of the overt image. As this embodiment is a combination of the third and fourth embodiments, it will exhibit all of the optical effects of the third embodiment for domains in the first subset 8 and all of the optical effects of the fourth embodiment for domains in the second subset 8a.

In a non-limiting example of the fifth embodiment, FIG. 4A, a patterned LH-CLCP 2 comprises of Green-reflecting background domain 9 and a Red-reflecting text domain 8 and a logo domain 8a. A Red-emitting fluorescent dye is embedded only in the text domain 8 and a Green-emitting fluorescent dye is embedded only in the logo domain 8a. When viewed at normal to the device under UV illumination 71, FIG. 4B, the CLCP transmits the RH Red emission polarization 75 from the text 8 but suppresses the text's LH component except for an emission spike at the long wavelengths side of the Red-reflecting band. Under the same conditions, the CLCP transmits equally both circular polarizations 77 of the logo's 8a Green emission which appears bright. When viewed at large angles, the Red-emission is outside the blue-shifted reflection band of the text domains causing the Red-emission 76 from 8 to become brighter while the Green-emission 78 from the logo domain 8a becomes darker as it is inside the blue-shifted reflection band of 8a. As a result, when the device is viewed through a LH polarizer and the viewing angle varies from near normal to large angles, the text 8 becomes brighter and its color shifts from dark-Red to Red while the logo 8a becomes darker and its color shifts from Green to Green-Yellow.

What is claimed is:

1. A patterned OVD and luminescent device comprises a substrate, a CLCP layer and an optional transparent top layer. Where the patterned CLCP layer reflects one circular polarization, and where its background domains reflect a first color and its image domains reflect a second color or multiple colors; and where a subset of the pattern's domains is embedded with one or more invisible luminescent dyes or pigments, part of which emit one or more partially polarized emission colors when illuminated with UV radiation.

2. A device as in claim 1 where the reflected polarization is essentially left-handed or right-handed.

3. A device as in claim 1 where the luminescent materials are fluorescent.

4. A device as in claim 1 where part of the luminescent materials comprises fluorescent dichroic molecules.

5. A device as in claim 1 where the luminescent materials are embedded in the CLCP layer over the entire device area.

6. A device as in claim 1 comprises one or more distinct fluorescent materials, part of which have their emission peaks within the reflection bands of one or more domains in said CLCP.

7. An authentication or security label or laminate device as in claim 1.

8. An authentication method of a patterned device as in claim 1 comprises of illuminating said device by UV radiation and detecting brightness or color variations of the covert luminescent images by a circular polarizer or by interchanging two distinct circular polarizers or by varying the viewing angle.

9. An authentication method of a patterned device as in claim 1 comprises naked-eye detection of a simultaneous OVD effects in multiple colored domains by varying the viewing angle or by observing changes in the reflected brightness or colors from said device when viewed through one or two interchanging distinct circular polarizers.

10. A patterned OVD and luminescent device comprises a substrate, a first luminescent print or a patterned luminescent layer and a second patterned CLCP layer. Said luminescent component comprises a covert pattern of one or more invisible luminescent dyes or pigments and said second CLCP layer, reflecting one circular polarization, comprises an overt pattern of background domains reflecting a first color and image domains reflecting a second color or multiple colors; and said device emits partially polarized luminescent colors when illuminated with UV radiation.

11. A device as in claim 10 where the first luminescent layer and the second CLCP layer are on opposite sides of a transparent substrate.

12. A device as in claim 10 where the reflected polarization is essentially left-handed or right-handed.

13. A device as in claim 10 where the luminescent materials are fluorescent.

14. A device as in claim 10 where the luminescent materials are uniformly embedded in said first layer.

15. A device as in claim 10 comprises one or more distinct fluorescent materials, part of which have their emission peaks within the reflection bands of one or more domains in said CLCP layer.

16. An authentication or security label or laminate device as in claim 10.

17. An authentication method of the patterned device as in claim 10 comprises of illuminating said device by UV radiation and detecting brightness variations of the covert luminescent images by a circular polarizer or by interchanging two distinct circular polarizers or by varying the viewing angle.

18. An authentication method of a patterned device as in claim 10 comprises naked-eye detection of a simultaneous OVD effects in multiple colored domains by varying the viewing angle or by observing changes in the reflected brightness or colors from said device when viewed through one or two interchanging distinct circular polarizers.
